(19) United States
(12) Patent Application Publication
(10) Pub. No.: US 2005/0083269 A1
(43) Pub. Date: Apr. 21, 2005

(54) [DRIVING METHOD OF IMPROVING BRIGHTNESS UNIFORMITY OF OLED/PLED DISPLAY]

(76) Inventors: YU-HSIANG LIN, TAIPEI COUNTY (TW); CHIE-CHING LIN, HSINCHU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,987

(22) Filed: Jan. 30, 2004

(30) Foreign Application Priority Data
Oct. 21, 2003 (TW) 92129092

(51) Int. Cl. G09G 3/30

(52) U.S. Cl. 345/76

(57) ABSTRACT

A driving method for improving uniformity of the brightness of pixels in an OLED/PLED display is provided. The method controls the light-on signal according to the driving display data after it is loaded, so that the pulse-width of the light-on signal is function-ally dependent of the quantity of OLED display pixels to be lit-on. Hence, any brightness uniformity of the OLED/PLED display due to insufficient circuit driving capacity is significantly improved.

### CROSS REFERENCE TO RELATED APPLICATIONS

This application claims the priority benefit of Taiwan application serial no.92129092, filed on Oct. 21, 2003.

### BACKGROUND OF INVENTION

1. Field of the Invention

The present invention relates to a method of driving an Organic Light-Emitting Diode (OLED)/Polymer Light-Emitting Diode (PLED) display. More particularly, the present invention relates to a driving method that improves brightness uniformity of an OLED/PLED display.

2. Description of the Related Art

With rapid progress in electronic technologies, various types of digital processing devices including computers, mobile phones, Personal Digital Assistants (PDAs), and digital cameras have been developed. In this information era, displays are an important machine/human interface. Since a flat panel display possesses the characters of thinness, lightness, and consuming minor power, this display option is popularized significantly.

Among various types of flat panel displays, Organic Light-Emitting Diode (OLED)/Polymer Light-Emitting Diode (PLED) displays are the most popular items. Major advantages of the OLED/PLED displays include a wide viewing angle, a high color contrast ratio, a rapid response and a low fabrication cost, and hence are frequently used in small dimensional displays such as digital clocks, mobile phones, PDAs, and digital cameras.

In general, the brightness of each pixel on an OLED/PLED display is represented by a driving data. After loading the driving data through a sequence of loading signals, each pixel of the OLED/PLED is lit up to a particular brightness by a lighting signal sequence according to the driving data.

FIG. 1 is a timing diagram showing the driving traces of a conventional OLED/PLED display. As shown in FIG. 1, the trace labeled ‘DATA’ represents the driving data of a row of pixels captured in a scanning operation. The driving data ‘DATA’ are loaded at the falling edge of a loading signal LD. Thereafter, a light-on signal ‘Light_on’ is maintained for a fixed interval ‘T’ to control the lighting sweep of the OLED/PLED pixels. However, for this type of driving method, pixel brightness often varies according to various driving data caused by insufficient circuit driving capacity, regardless of whether a constant current or a constant voltage driving circuit is provided.

### SUMMARY OF INVENTION

Accordingly, at least one object of the present invention is to provide a driving method capable of improving brightness uniformity of pixels on an Organic Light-Emitting Diode (OLED)/Polymer Light-Emitting Diode (PLED) display. The method comprises setting a light-on period for each pixel according to a driving data so that the brightness uniformity of each pixel on the OLED/PLED display is improved.

To achieve these and other advantages and in accordance with the purpose of the invention, as embodied and broadly described herein, the invention provides a driving method to improve the brightness uniformity of pixels on an OLED/PLED display. First, the driving data representing the brightness level of each pixel on the OLED/PLED display is loaded. Thereafter, the light-on period for each pixel on the OLED/PLED is adjusted according to the loaded driving data.

In one embodiment of this invention, the driving method of improving brightness uniformity of an OLED/PLED display comprises loading the aforementioned driving data according to loaded signals.

In one embodiment of this invention, the driving method of improving brightness uniformity of an OLED/PLED display comprises loading the aforementioned driving data are at the falling edge of the loading signals.

In one embodiment of this invention, the driving method of improving brightness uniformity of an OLED/PLED display comprises controlling the light-on period for each row of pixels on the OLED/PLED display with a light-on signal.

In one embodiment of this invention, the driving method of improving uniformity of brightness of OLED/PLED display comprises controlling the light-on signal with the driving data, such that the pulse width of the light-on signal is a functionally dependent of the number of pixels to be turned on.

Accordingly, this invention provides a driving method to improve the brightness uniformity of pixels on an OLED/PLED display. The method adjusts the light-on period of each pixel according to loaded driving data so that to compensate any insufficient circuit driving capacity, and thus improving the brightness uniformity of the OLED/PLED display.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a timing diagram illustrating the driving traces of a conventional OLED/PLED display.

FIG. 2 is a timing diagram illustrating the driving traces of an OLED/PLED display with improved brightness uniformity according to one preferred embodiment of this invention.

FIG. 3 is a flow chart diagram illustrating the steps of the driving method of improving brightness uniformity of the OLED/PLED display according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

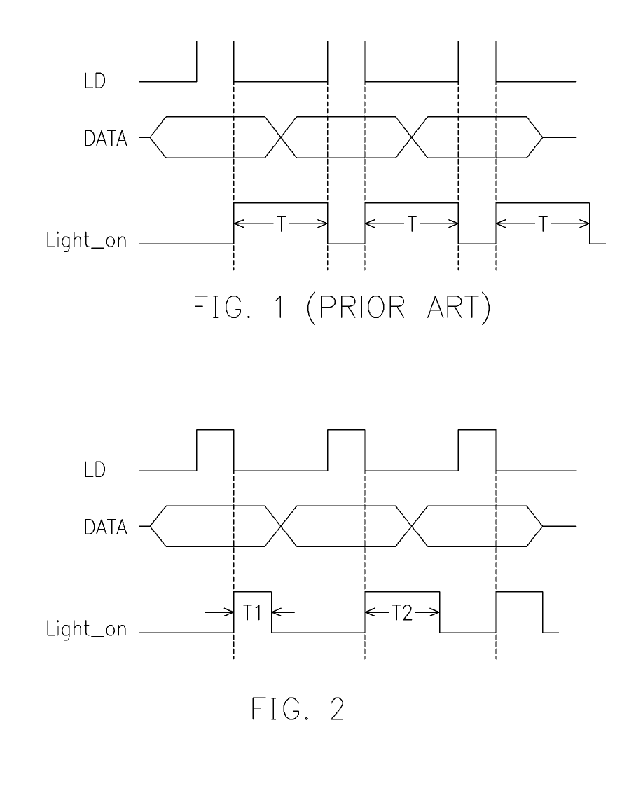

FIG. 2 is a timing diagram illustrating the driving traces of an OLED/PLED display with improved brightness uniformity according to one preferred embodiment of this invention. In general, the organic light-emitting diode display can exemplarily be a common Organic Light-Emitting Diode (OLED) display or a Polymer Light-Emitting Diode (PLED) display.

Similarly, the labeled trace “DATA” in FIG. 2 refers to the driving data of a row of pixels captured in a scanning operation. The driving data “DATA” are loaded via loading signals LD at, generally, the falling edge of a loading signal LD so that a row of pixels on the OLED/PLED display is driven as soon as the light-on signal is enabled.

Since the driving data loaded in each scanning operation differs according to the image, the number of pixels on the OLED/PLED display to be turned on varies as well. Hence, pixel brightness often varies when driven according to various driving data if there is insufficient circuit driving capacity, regardless of whether a constant current or a constant voltage is supplied. In other words, overall brightness of the OLED/PLED display is rather unstable.

To resolve this problem, the brightness level of each pixel in the OLED/PLED display is modulated by the light-on signal. If the number of pixels in the OLED/PLED display that needs to be turned on is large, the pulse width of the light-on signal is increased to T2, for example. On the other hand, if the number of pixels in the OLED/PLED display that needs to be turned on is small, the pulse width of the light-on signal is decreased to T1, for example. In this way, any brightness change of a pixel caused by insufficient circuit driving capacity can be compensated.

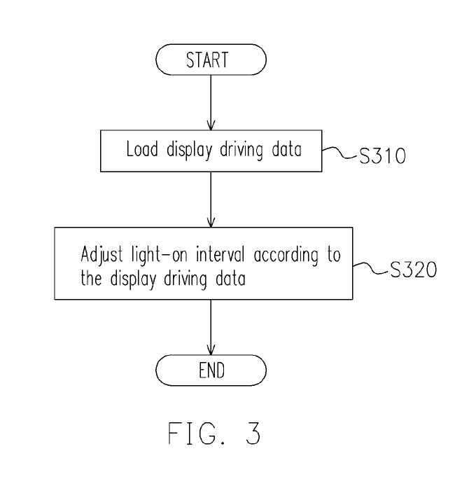

FIG. 3 is a flow chart showing the steps of improving brightness uniformly of the OLED/PLED display according to one preferred embodiment of this invention. As shown in FIG. 3, the driving data representing the brightness of each pixel on the OLED/PLED display is loaded in step S310. Thereafter, the light-on interval of each pixel on the OLED/PLED display is adjusted according to the loaded driving data in step S320.

As shown in FIG. 2, the driving method of improving the brightness uniformity of an OLED/PLED display comprises loading the driving data ‘DATA’ according to the signal LD, and furthermore, at the falling edge of a loading signal LD.

After loading the driving data ‘DATA’, the light-on signals control the light-on interval of the pixels on the OLED/PLED display. The light-on signal refers to the driving data such that the pulse width of the light-on signal is a functionally dependent oftemptemp the number of pixels on the OLED/PLED display to be turned on according to the driving data. Ultimately, any changes of the pixel brightness caused by insufficient circuit driving capacity are compensated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A driving method of improving a brightness uniformity of a plurality of pixels on an Organic Light-Emitting Diode (OLED)/Polymer Light-Emitting Diode (PLED) display, comprising the steps of:
loading a plurality of driving data representing a brightness of each of the pixels on the OLED/PLED display; and adjusting a light-on interval of each of the pixels on the OLED/PLED display according to the driving data.

2. The driving method as recited in claim 1, wherein the driving data is loaded based on a loading signal.

3. The driving method as recited in claim 2, wherein the driving data is loaded at a falling edge of the loading signal.

4. The driving method as recited in claim 1, wherein a light-on signal controls the light-on interval of each of the pixels on the OLED/PLED display.

5. The driving method as recited in claim 4, wherein a pulse width of the light-on signal is a functionally dependent of a number of the pixels on the OLED/PLED display that are to be turned on by the driving data.
